(19) United States
(12) Patent Application Publication
(10) Pub. No.: US 2014/0327584 A1
(43) Pub. Date: Nov. 6, 2014

(54) MOBILE DEVICE WITH COUPLED-FED ANTENNA STRUCTURE

(71) Applicant: Acer Incorporated, New Taipei City (TW)

(72) Inventor: Chih-Hua CHANG, New Taipei City (TW)

(73) Assignee: Acer Incorporated, New Taipei City (TW)

(21) Appl. No.: 13/970,848

(22) Filed: Aug. 20, 2013

(30) Foreign Application Priority Data
May 3, 2013 (TW) 102115838

(51) Int. Cl. H01Q 1/24

(52) U.S. Cl. CPC H01Q 1/243
USPC 343/702

(57) ABSTRACT

A mobile device includes a ground element, a first conductive frame, a second conductive frame, and an antenna element. The first conductive frame is coupled to the ground element. The second conductive frame is separated from the ground element and the first conductive frame. The antenna element is coupled to a signal source, and is disposed adjacent to the second conductive frame. A coupled-fed antenna structure is formed by the antenna element and the second conductive frame.

### CROSS REFERENCE TO RELATED APPLICATIONS

This Application claims priority of Taiwan Patent Application No. 102115838 filed on May 3, 2013, the entirety of which is incorporated by reference herein.

### BACKGROUND OF THE INVENTION

1. Field of the Invention

The disclosure generally relates to a mobile device, and more particularly, relates to a mobile device comprising a coupled-fed antenna structure formed by a float conductive frame.

2. Description of the Related Art

With the progress of mobile communication technology, portable electronic devices, for example, portable computers, mobile phones, tablet computer, multimedia players, and other hybrid functional mobile devices, have become more common To satisfy the demand of users, portable electronic devices usually can perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

In recent years, metal materials are often incorporated into mobile devices to achieve desired aesthetic appearances. However, the existence of the metal materials negatively affects the antenna elements for wireless communication and degrades the communication quality of the mobile devices.

### BRIEF SUMMARY OF THE INVENTION

In one exemplary embodiment, the disclosure is directed to a mobile device, comprising: a ground element; a first conductive frame, coupled to the ground element; a second conductive frame, separated from the ground element and the first conductive frame; and a first antenna element, coupled to a first signal source, and disposed adjacent to the second conductive frame, wherein a first coupled-fed antenna structure is formed by the first antenna element and the second conductive frame.

### BRIEF DESCRIPTION OF DRAWINGS

The invention can be more fully understood by reading the subsequent detailed description and examples with references made to the accompanying drawings, wherein:

FIG. 1 is a perspective view for illustrating a mobile device according to an embodiment of the invention;

FIG. 2 is a top view for illustrating a mobile device according to an embodiment of the invention;

FIG. 3A is a perspective view for illustrating a mobile device according to an embodiment of the invention;

FIG. 3B is a top view for illustrating a mobile device according to an embodiment of the invention;

FIG. 4 is a diagram for illustrating return loss of a first antenna element and a first coupled-fed antenna structure of a mobile device according to an embodiment of the invention;

FIG. 5 is a diagram for illustrating antenna efficiency of a first antenna element and a first coupled-fed antenna structure of a mobile device according to an embodiment of the invention; and

FIG. 6 is a perspective view for illustrating a mobile device according to an embodiment of the invention.

### DETAILED DESCRIPTION OF THE INVENTION

In order to illustrate the purposes, features and advantages of the invention, the embodiments and figures thereof in the invention are shown in detail as follows.

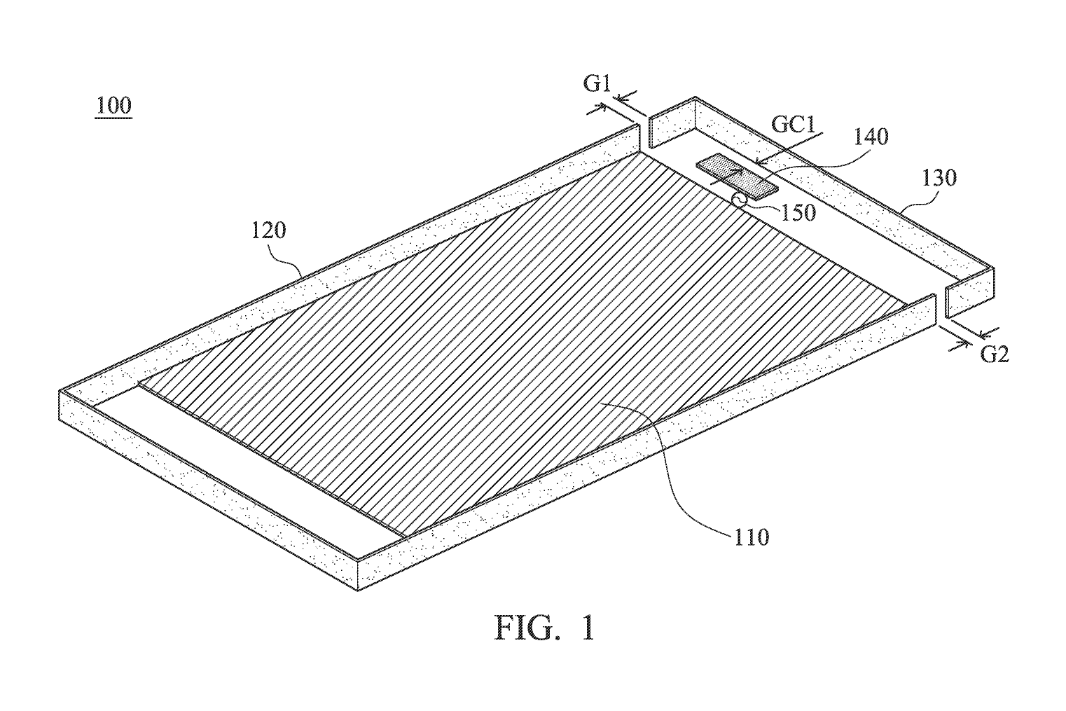

FIG. 1 is a perspective view for illustrating a mobile device 100 according to an embodiment of the invention. The mobile device 100 may be a smart phone or a tablet computer. As shown in FIG. 1, the mobile device 100 comprises a ground element 110, a first conductive frame 120, a second conductive frame 130, a first antenna element 140, and a signal source 150. The ground element 110 may be a system ground plane, which is disposed on a dielectric substrate (not shown), such as an FR4 (Flame resistant −4) substrate. In some embodiments, the ground element 110, the first conductive frame 120, the second conductive frame 130, and the first antenna element 140 are all made of metal, such as copper, silver, aluminum, or iron. Note that the mobile device 100 may further comprise other components, such as a processor, a touch panel, a touch module, a battery, a speaker, and a camera lens (not shown).

The first conductive frame 120 may be coupled to the ground element 110. The second conductive frame 130 is separated from the ground element 110 and the first conductive frame 120. In other words, the second conductive frame 130 is floating, and is considered as a parasitic element which is independent of the ground element 110. In some embodiments, the first conductive frame 120 substantially has a U-shape, and the second conductive frame 130 substantially has another U-shape, wherein a length of the second conductive frame 130 is smaller than a length of the first conductive frame 120. A first gap

G1 and a second gap G2 are formed between the first conductive frame 120 and the second conductive frame 130. In some embodiments, a length of each of the first gap G1 and the second gap G2 is greater than 1 mm. The first antenna element 140 is coupled to the first signal source 150, and is disposed adjacent to the second conductive frame 130. The type of the first antenna element 140 is not limited in the invention. For example, the first antenna element 140 may be a monopole antenna, a dipole antenna, a loop antenna, a PIFA (Planar Inverted F Antenna), a dual-branch antenna, or a patch antenna. A first coupling gap GC1 is formed between the first antenna element 140 and the second conductive frame 130. In some embodiments, a length of the first coupling gap GC1 is smaller than 3 mm. A first coupled-fed antenna structure is further formed by the first antenna element 140 and the second conductive frame 130, wherein the first antenna element 140 is considered as a first feeding element for exciting the first coupled-fed antenna structure.

In the invention, the first antenna element 140 is configured to cover a high band, and the first coupled-fed antenna structure formed by the first antenna element 140 and the second conductive frame 130 is configured to cover a low band. Since the second conductive frame 130 is floating and decoupled from the ground element 110, the effect of the second conductive frame 130 on the whole antenna radiation performance of the mobile device 100 is reduced. In addition, the second conductive frame 130 is a portion (parasitic element) of the first coupled-fed antenna structure, thus, beneficial to the operation of multiple bands of the mobile device 100. Accordingly, the invention has the advantages of both improving the appearance of the mobile device and maintaining the antenna radiation performance.

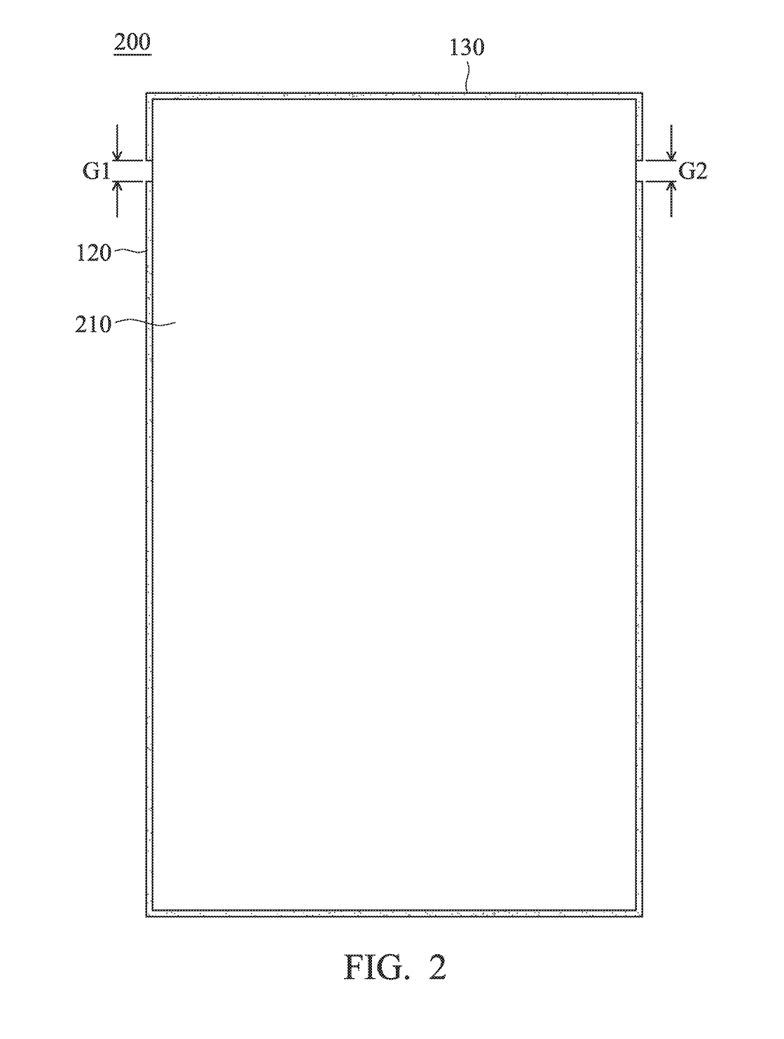

FIG. 2 is a top view for illustrating a mobile device 200 according to an embodiment of the invention. FIG. 2 is similar to FIG. 1. The difference from the embodiment of FIG. 1 is that the mobile device 200 further comprises a nonconductive housing 210. For example, the nonconductive housing 210 is made of plastic materials. In the embodiment, the first conductive frame 120 and the second conductive frame 130 are both disposed on surfaces of the nonconductive housing 210, and the ground element 110 is disposed in the nonconductive housing 210 (not shown). The length of the second conductive frame 130 is smaller than the length of the first conductive frame 120. Other features of the mobile device 200 of FIG. 2 are similar to those of the mobile device 100 of FIG. 1. Accordingly, the two embodiments can achieve similar performances.

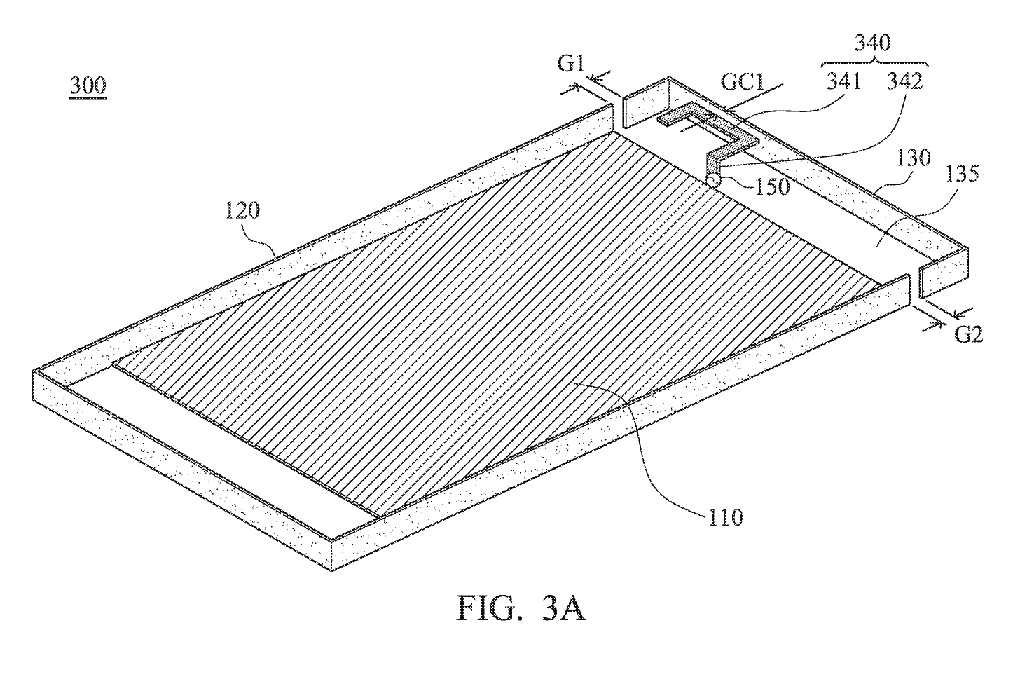

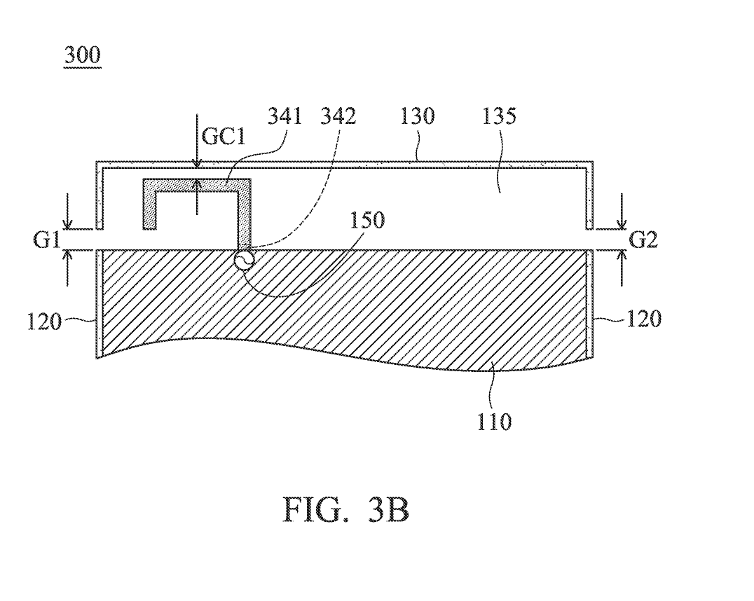

FIG. 3A is a perspective view for illustrating a mobile device 300 according to an embodiment of the invention. FIG. 3B is a top view for illustrating the mobile device 300 according to an embodiment of the invention. Please refer to FIG. 3A and FIG. 3B together. FIGS. 3A and 3B are similar to FIG. 1. The difference from the embodiment of FIG. 1 is that a first antenna element 340 of the mobile device 300 is a monopole antenna with a meandering structure. The monopole antenna comprises a main radiation element 341 and a feeding connection element 342. The main radiation element 341 is disposed adjacent to the second conductive frame 130. A first coupling gap GC1 is formed between the main radiation element 341 and the second conductive frame 130. In some embodiments, the main radiation element 341 substantially has a U-shape. The main radiation element 341 and the ground element 110 may be disposed on different planes. For example, the main radiation element 341 may be disposed on an FPCB (Flexible Printed Circuit Board) (not shown) which is different from the ground element 110. The first signal source 150 is coupled through the feeding connection element 342 to the main radiation element 341. In some embodiments, the feeding connection element 342 is a pogo pin or a metal spring, and is substantially perpendicular to the ground element 110 and the FPCB. In some embodiments, a first non-grounding region 135 is formed between the second conductive frame 130 and the ground element 110, and the first antenna element 340 has a vertical projection which partially or completely overlaps with the first non-grounding region 135. Other features of the mobile device 300 of FIGS. 3A and 3B are similar to those of the mobile device 100 of FIG. 1. Accordingly, the two embodiments can achieve similar performances.

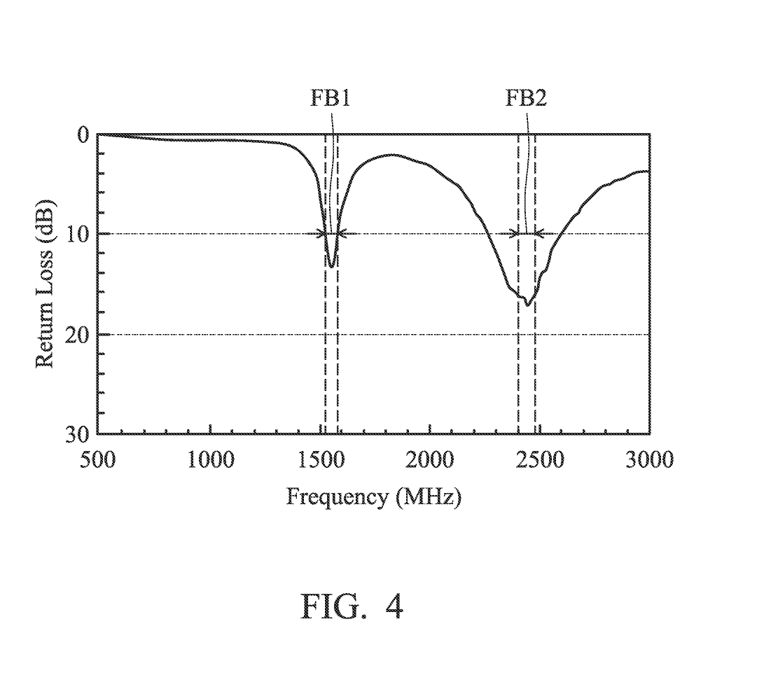

FIG. 4 is a diagram for illustrating return loss of the first antenna element 140 and the first coupled-fed antenna structure of the mobile device 100 according to an embodiment of the invention. The horizontal axis represents operation frequency (MHz), and the vertical axis represents the return loss (dB). As shown in FIG. 4, the first coupled-fed antenna structure covers a first band FB1, and the first antenna element 140 covers a second band FB2. In a preferred embodiment, the first band FB1 is approximately from 1565 MHz to 1585 MHz, and the second band FB2 is approximately from 2400 MHz to 2484 MHz. Accordingly, the mobile device 100 of the invention can operate in at least a GPS (Global Positioning System) band and a WLAN (Wireless Local Area Network) 2.4 GHz band.

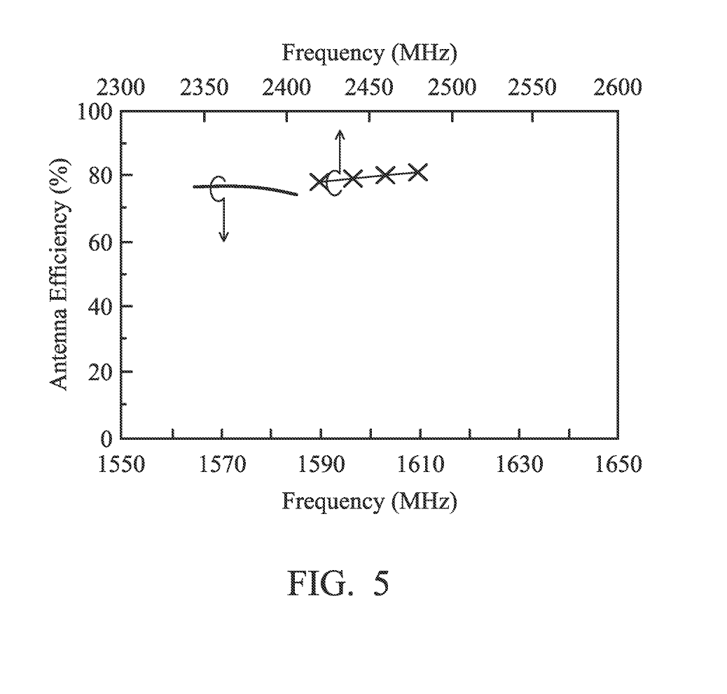

FIG. 5 is a diagram for illustrating antenna efficiency of the first antenna element 140 and the first coupled-fed antenna structure of the mobile device 100 according to an embodiment of the invention. The horizontal axis represents operation frequency (MHz), and the vertical axis represents the antenna efficiency (%). As shown in FIG. 5, the antenna efficiency of the first antenna element 140 and the first coupled-fed antenna structure is approximately from 74% to 76% in the first band FB1 and is approximately from 77% to 81% in the second band FB2. The antenna efficiency of the invention can meet practical application requirements.

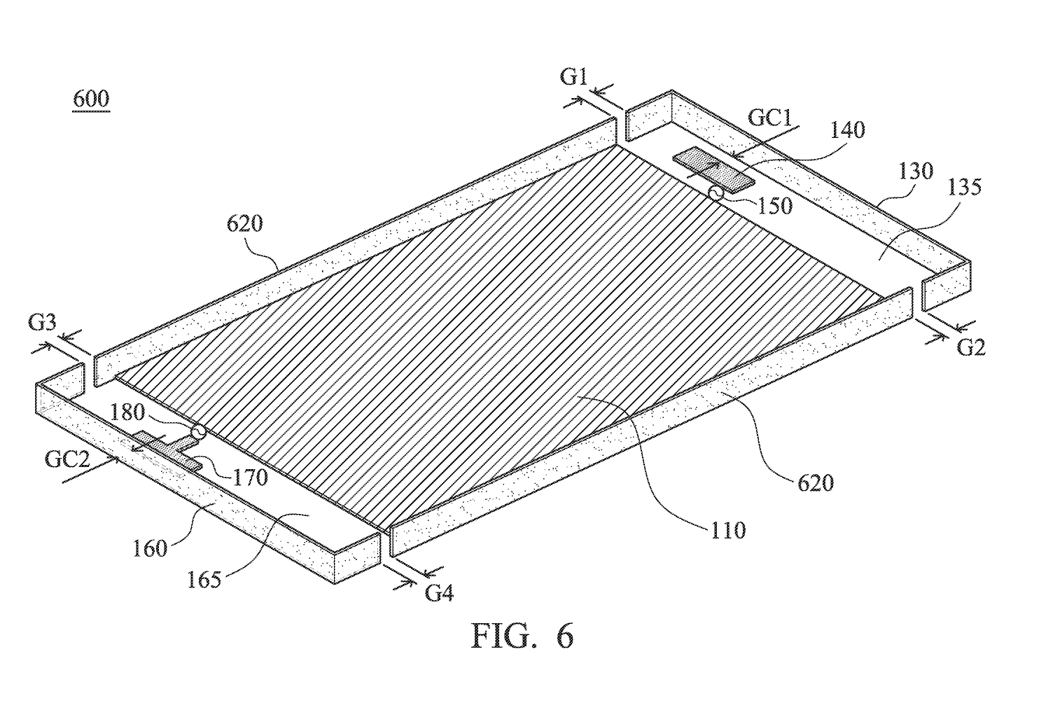

FIG. 6 is a perspective view for illustrating a mobile device 600 according to an embodiment of the invention. FIG. 6 is similar to FIG. 1. The difference from the embodiment of FIG. 1 is that the mobile device 600 further comprises a third conductive frame 160, a second antenna element 170, and a second signal source 180, and furthermore, a first conductive frame 620 of the mobile device 600 has a different shape. In some embodiments, the third conductive frame 160 and the second antenna element 170 are both made of metal, such as copper, silver, aluminum, or iron. In some embodiments, the first conductive frame 620, the second conductive frame 130, and the third conductive frame 160 are all disposed on surfaces of a nonconductive housing (not shown), and the ground element 110 is disposed in the nonconductive housing. The first conductive frame 620 may be coupled to the ground element 110. The third conductive frame 160 is separated from the ground element 110 and the first conductive frame 620. In some embodiments, the third conductive frame 160 substantially has a U-shape. A third gap G3 and a fourth gap G4 are formed between the first conductive frame 620 and the third conductive frame 160. In some embodiments, a length of each of the third gap G3 and the fourth gap G4 is greater than 1 mm. The second antenna element 170 is coupled to the second signal source 180, and is disposed adjacent to the third conductive frame 160. The type of the second antenna element 170 is not limited in the invention. For example, the second antenna element may be a dual-branch antenna. A second coupling gap GC2 is formed between the second antenna element 170 and the third conductive frame 160. In some embodiments, a length of the second coupling gap GC2 is smaller than 3 mm. A second coupled-fed antenna structure is further formed by the second antenna element 170 and the third conductive frame 160, wherein the second antenna element 170 is considered as a second feeding element for exciting the second coupled-fed antenna structure. In some embodiments, a first non-grounding region 135 is formed between the second conductive frame 130 and the ground element 110, and the first antenna element 140 has a vertical projection which partially or completely overlaps with the first non-grounding region 135. In some embodiments, a second non-grounding region 165 is formed between the third conductive frame 160 and the ground element 110, and the second antenna element 170 has a vertical projection which partially or completely overlaps with the second non-grounding region 165. Other features of the mobile device 600 of FIG. 6 are similar to those of the mobile device 100 of FIG. 1. Accordingly, the two embodiments can achieve similar performances.

In some embodiments, sizes and parameters of the element of the invention are as follows. Refer to FIGS. 3A and 3B together again. The ground element 110 has a length of about 100 mm and a width of about 65 mm. The first conductive frame 120 has a length of about 295 mm and a height of about 4 mm. The second conductive frame 130 has a length of about 81 mm and a height of about 4 mm. The first gap G1 has a length of about 2 mm. The second gap G2 has a length of about 2 mm. The first antenna element 340 has a length of about 30 mm and a height of about 3 mm. The first coupling gap GC1 has a length of about 1 mm. The first non-grounding region 135 has a length of about 10 mm and a width of about 65 mm.

Note that the above element sizes, element parameters, element shapes, and frequency ranges are not limitations of the invention. An antenna designer may adjust these settings according to different requirements.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a ground element;
a first conductive frame, coupled to the ground element;
a second conductive frame, separated from the ground element and the first conductive frame; and
a first antenna element, coupled to a first signal source, and disposed adjacent to the second conductive frame, wherein a first coupled-fed antenna structure is formed by the first antenna element and the second conductive frame.

2. The mobile device as claimed in claim 1, wherein the first conductive frame substantially has a U-shape.

3. The mobile device as claimed in claim 1, wherein the second conductive frame substantially has a U-shape.

4. The mobile device as claimed in claim 1, wherein a length of the second conductive frame is smaller than a length of the first conductive frame.

5. The mobile device as claimed in claim 1, wherein a first gap and a second gap are formed between the first conductive frame and the second conductive frame, and a length of each of the first gap and the second gap is greater than 1 mm.

6. The mobile device as claimed in claim 1, wherein a first coupling gap is formed between the first antenna element and the second conductive frame, and a length of the first coupling gap is smaller than 3 mm.

7. The mobile device as claimed in claim 1, wherein the first antenna element is a monopole antenna which comprises:
a main radiation element, disposed adjacent to the second conductive frame, wherein the main radiation element substantially has a U-shape, and wherein the main radiation element and the ground element are disposed on different planes; and
a feeding connection element, wherein the first signal source is coupled through the feeding connection element to the main radiation element.

8. The mobile device as claimed in claim 7, wherein the feeding connection element is a pogo pin or a metal spring.

9. The mobile device as claimed in claim 1, wherein the first coupled-fed antenna structure covers a first band, the first antenna element covers a second band, and frequencies of the first band are lower than frequencies of the second band.

10. The mobile device as claimed in claim 1, further comprising:
a third conductive frame, separated from the ground element and the first conductive frame, wherein the third conductive frame substantially has a U-shape; and
a second antenna element, coupled to a second signal source, and disposed adjacent to the third conductive frame, wherein a second coupled-fed antenna structure is formed by the second antenna element and the third conductive frame.

11. The mobile device as claimed in claim 10, wherein a third gap and a fourth gap are formed between the first conductive frame and the third conductive frame, and a length of each of the third gap and the fourth gap is greater than 1 mm.

12. The mobile device as claimed in claim 10, wherein a second coupling gap is formed between the second antenna element and the third conductive frame, and a length of the second coupling gap is smaller than 3 mm.
